(19) United States
(12) Patent Application Publication
(10) Pub. No.: US 2020/0136374 A1
(43) Pub. Date: Apr. 30, 2020

(54) THERMAL FUSE BREAKER FOR SMART SOCKET

(71) Applicant: Ibis Networks, Honolulu, HI (US)

(72) Inventor: James G. Hagerman, Honolulu, HI (US)

(73) Assignee: Ibis Networks, Honolulu, HI (US)

(21) Appl. No.: 16/539,978

(22) Filed: Aug. 13, 2019

Related U.S. Application Data
(60) Provisional application No. 62/752,837, filed on Oct. 30, 2018.

(51) Int. Cl. H02H 7/22; H01R 13/713; H02H 1/00

(52) U.S. Cl. CPC H02H 7/22; H01R 13/7137; H01R 24/76; H02H 1/0092; H02H 1/0007

(57) ABSTRACT

A smart electrical socket includes an electrical socket, an output relay, an energy unit, and a control unit. The output relay is connected between a power line and the electrical socket and upon receipt of a deactivation signal from the control unit can remove the power to the electrical socket. The energy unit includes an interrupt status register to provide an accurate interval timer. The control unit includes a processor and a temperature sensor, and the temperature is measured at certain time intervals provided by the energy unit, at the processor or at the electrical socket. The output relay is operated to shut off the power to a load if the temperature is greater than a threshold temperature.

### CROSS-REFERENCE TO RELATED APPLICATIONS

This application claims the benefit of U.S. provisional patent application Ser. No. 62/752,837, filed on Oct. 30, 2018, the contents of which are incorporated herein by reference in their entirety.

### BACKGROUND

Electrical fires are common, and many may be caused by heat generated from a poor electrical connection at an outlet interface. The causes for bad conductivity may include corrosion, small contact area, weak contact pressure, and partial disconnection. A failed contact may become resistive, which may lead to excessive heat dissipation during high current loads. Extension cords, power strips, and smart sockets all may succumb to such abnormal operating conditions resulting in a meltdown. Therefore, there is a need to prevent socket failure, meltdowns, fires, or any such damage possible from a failed outlet electrical connection.

### BRIEF SUMMARY

Methods and devices disclosed herein provide a smart electrical socket and methods of protecting the smart electrical socket from thermal events. The methods may include monitoring an internal temperature of the smart electrical socket connected to a load, comparing the internal temperature to a threshold temperature and sending a deactivation signal to the output relay if the internal temperature is above the threshold temperature. The smart electrical socket may include an electrical socket, an output relay, an energy unit and a control unit. The output relay may be connected between the electrical socket and a power line and upon receipt of a deactivation signal may remove the power line to the electrical socket. The energy unit may include a processor and a temperature sensor. The temperature sensor is controlled by the processor and measures the internal temperature of the electrical socket at a regular time interval. The control unit may include a processor that includes logic to determine if the internal temperature is above a threshold temperature and to send a deactivation signal to the output relay to shut off the power line to the load.

The smart electrical socket may include an electrical socket, an output relay, a timer, and a control unit. The output relay is connected between a power line and the electrical socket and upon receipt of a deactivation signal removes an electrical connection between the power line and the electrical socket. The timer comprises an interrupt status register and logic to provide an accurate interval timer from the interrupt status register for sending out report packets. The control unit comprises a processor and a temperature sensor.

A method of operating a system of smart electrical sockets to protect power lines in a building, connected loads, and the smart electrical sockets may involve positioning a smart electrical socket between a load and a power line, wherein the smart electrical socket comprises an electrical socket, an output relay, a timer, and a control unit. The method may monitor an internal temperature of the smart electrical socket connected to the load through operation of the timer and the control unit, wherein the timer comprises an interrupt status register, and the control unit comprise a processor and a temperature sensor. The method may operate logic on the timer to provide an accurate interval timer for sending out report packets to the control unit.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a circuit 100 in accordance with one embodiment.

FIG. 2 illustrates a method 200 in accordance with one embodiment.

FIG. 3 illustrates a system 300 in accordance with one embodiment.

FIG. 4 illustrates an environment 400 in accordance with one embodiment.

FIG. 5 illustrates a smart electrical socket 500 in accordance with one embodiment.

FIG. 6 illustrates an environment 600 in accordance with one embodiment.

FIG. 7 illustrates a chip 700 in accordance with one embodiment.

FIG. 8 is an example block diagram of a device 800 that may incorporate embodiments of the present invention.

### DETAILED DESCRIPTION

The present disclosure provides a thermal fuse breaker within a smart electrical socket that monitors a thermal event at the interface of the smart electrical socket and a load or appliance and breaks the circuit if a thermal event occurs. The smart electrical socket may also alert the user and send information that includes the current and internal temperature.

When the internal temperature of the smart electrical socket is above a threshold temperature, the current flow is interrupted, thereby removing current flow from the load and thus minimizing the likelihood of an electrical hazard. Alerting the user assists the user in locating the tripped smart electrical socket. Reporting the current and temperature values may enable the user to diagnose the cause of the problem.

Additionally, the smart electrical socket monitors the normal operating internal temperatures of the smart electrical sockets and may identify which sockets may be in danger, thus providing early detection of a potentially hazardous condition, allowing plugs and outlets to be replaced prior to any damaging event. This may be valuable in the operation and maintenance of the electrical facilities in buildings.

The methods include an efficient and accurate method for thermal measurement of electrical contact materials. As a result, both input and output contacts may be monitored. A poor connection leads to abnormal conditions of high contact resistance, resulting in lost power that is converted to heat. Power dissipation is given by, P=I²R. Power dissipation is proportional to current-squared, therefore the problem only manifests at higher currents. Examples of high current loads may include space heaters, microwave ovens, vacuum cleaners, large vending machine, ice makers, etc. During a failure condition, excessive heat can melt solder, plastic enclosures, circuit boards, and emit smoke.

The methods and devices may be provided to shut off the load current before temperatures get too high. A smart electrical socket may accomplish this by turning off the output relay when thermal measurements exceed a given threshold. The threshold temperature may be higher than the temperature that occurs during normal operation, and less than the melting point of solder or plastic.

In an embodiment, the contact temperature may not be measured directly. The smart electrical socket may include a microprocessor that controls the operation. This processor may be mounted on a circuit board that may be soldered directly to the brass plug/outlet contacts. Via conduction, the processor may rise in temperature proportional to the temperature rise of the contacts. Using the internal temperature sensor of the processor, an algorithm may be applied to report temperatures at regular intervals and automatically turn off the relay when needed.

An example of a code for showing thermal sense and turn-off of relay may be:

//check temperature MyCelsius = ReadCelsius( ) − MyCelsiusOffset;
if(MyCelsius > CELSIUS_TRIP_LEVEL)
[//overheated! sprintf((char*)MyString, “!Overheated!\r\n”);
WRITE_STRING( ) ;
MyState = 0x00;
SetState( ) ;
SendAck(GET_CELSIUS, (uint32)MyCelsius) ; }

An example of a code to read internal temperature may be:

//readinternal temperaturee sensor
uint16 ReadCelsius(void)
{int16 reading;
// select internal temp as input to adc, resolution 10 bits
TRO = 0x01;
ATEST = 0x01;
ADCCON3 = 0x2E;
//wait for conversion to complete
while (!(ADCCON1 & 0x80)) ;
//read result
reading = ADCL;
reading = reading | (ADCH << 8) ;
// ignore negative
if(reading <0) reading = 0;
// shift to 10 bits
reading = reading >> 6;
return(reading); }

An example of a code for showing thermal sense and turn-off of the relay may be:

```
// check temperature
  if((MyModel == MODEL_IM_302) || (MyModel = MODEL IM 304))
{ // in-wall dual or switch with mcp3021 & thermistor (actual temp)
MyCelsius = (int16)((61440 − 59 * (int32) ConvertI2C (0x48)) >> 9); }
  else
  { // read cc2530 internal temp, apply calibration MyCelsius =
ReadCelsius ( ) − MyCelsiusOffset;
// estimate metal temperature using correlation factors, align with is-301
gain if (MyState)
  { if(MyModel = MODEL_IS_201)MyCelsius = MyCelsius +
(MyOnCurrent * MyOnCurrent) / 1500;
if(MyModel = MODEL_IS_302)MyCelsius = MyCelsius +
(MyOnCurrent * MyOnCurrent) / 2300; } }
```

An application such as a cloud service may be used to monitor smart electrical socket temperatures on a regular basis and determine which sockets may be at risk. Additionally, when a smart electrical socket exceeds the threshold temperature, an alert may be sent that the current to its load has been removed. This alert provides a notification of said abnormal condition, whereupon corrective remedies can be taken.

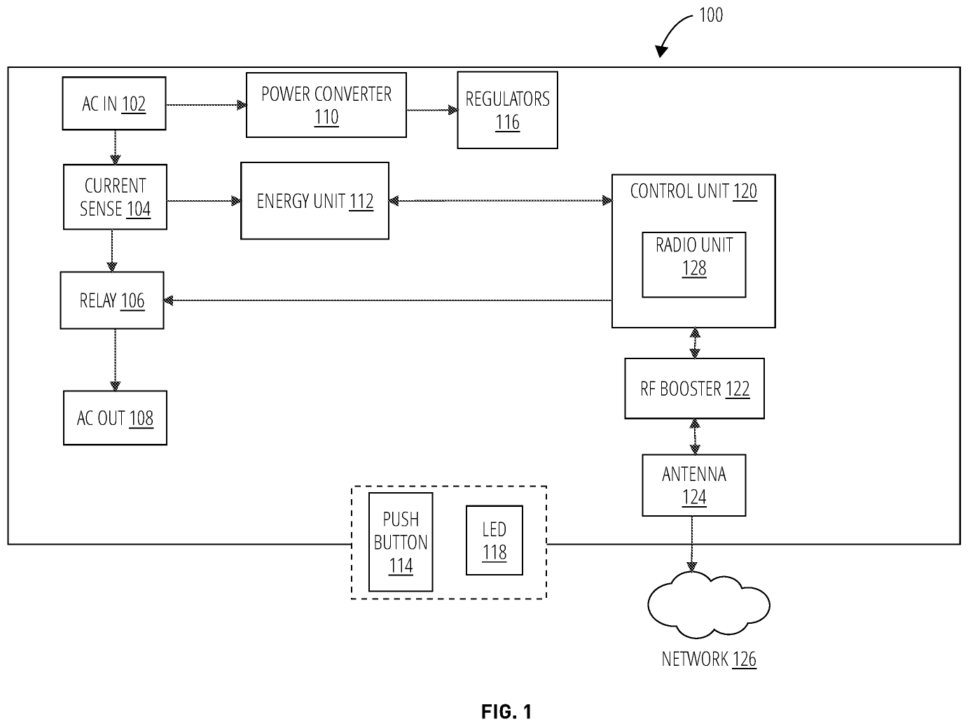

FIG. 1 shows a block diagram of a thermal fuse breaker circuit 100 within a smart electrical socket. The circuit 100 comprises an AC In 102, a current sense 104, a relay 106, an AC Out 108, a power converter 110, an energy unit 112, a push button 114, regulators 116, an LED 118, a control unit 120, an RF Booster 122, an Antenna 124, a network 126, and a radio unit 128.

An AC path may include AC In 102, current sense 104, relay 106 and AC Out 108. The line wire passes through the current sense 104 and relay 106. The line wire is the wire through which current flows to a device. An example of a current sense 104 device may include a resistor. The relay 106 controls the on/off state of the output to an electrical socket (AC Out 108). The Neutral wire is a pass-through, i.e., the current will pass through the Neutral wire anytime current passes through the line wire.

By using the line wire as a ground for the internal circuitry, the neutral wire may be used to provide an input for the power converter 110. The power converter 110 may be used to convert the AC input to a DC output of different voltages. For example, the power converter 110 may provide both +7V and −5V outputs. The difference of 12V may be used for the relay 106 driver.

Regulators 116 may be used to regulate the output voltage when the supply voltage is very close to the output voltage, i.e., to produce a low and steady voltage out. For example, a Linear LDO (low drop-out) regulator may convert the +7V into stable +5V and +3.3V supplies.

The energy unit 112 may include an energy meter chip, which provides sensing and processing for voltage, current, energy, frequency, and power factor. The energy unit, which may also be referred to as a timer, may include an interrupt status register that manages interrupts. Via interrupts, it provides an accurate interval timer for sending out report packets. This interval may be set to 15 seconds (1800 zero crossings) by default. The energy unit 112 monitors the internal temperature and reports the temperatures at regular intervals. Communication to the processor may be via an SPI bus. Example of an energy unit 112 may include ADE7753 chip that uses a 3.58 MHz clock.

The control unit 120 may include a radio unit 128 and a microprocessor in addition to many other internal peripherals. This microprocessor may be mounted on a circuit board that may be soldered directly to the brass plug/outlet contacts. Via conduction, the microprocessor will rise in temperature proportional to the contacts. Using the internal temperature sensor of the microprocessor, the temperatures may be reported at regular intervals and automatically turn off the relay when needed. The control unit 120 is programmed to compare these temperatures with a set threshold temperature value. When the internal temperature is above the threshold temperature, the control unit sends a deactivation signal that turns off the relay 106, thus shutting off the load current. The radio unit 128 may also receive information including voltage, current, internal temperature and the like. The radio unit 128 may broadcast the information to a user.

An example of control unit 120 may include a CC2530 wireless controller employing a 32 MHz crystal. The CC2530 includes a microprocessor and an analog-to-digital converter (ADC) that may also have a temperature-sensor input channel. A temperature may be measured on the chip itself or from a remotely located temperature sensor. In an embodiment, the remotely located sensor is in close proximity to the electrical socket. The wireless stack used may include ZigBee Pro 2007. A red/green LED 118 may be used to indicate the output state, and a push button 114 input provides user input (toggle state). The smart electrical socket may be turned on again after tripping, which may lead to another tripping event. The smart electrical socket may remain undamaged and continue to operate and maintain safe conditions.

An RF Booster 122 drives a chip Antenna 124 and may provide higher transmit power (+20 dBm) and a lower noise RF front end, resulting in a 4× gain in range. The information including current and temperature may be sent wirelessly on a network 126 to a remote server, such as a cloud server, from where the user may access the information. An example of RF Booster 122 may include a CC2592 wireless booster chip.

Additionally, there may be a dual socket that includes an extra non-switch outlet added, i.e., another energy unit. An example of the energy unit may include an ADE7753 chip.

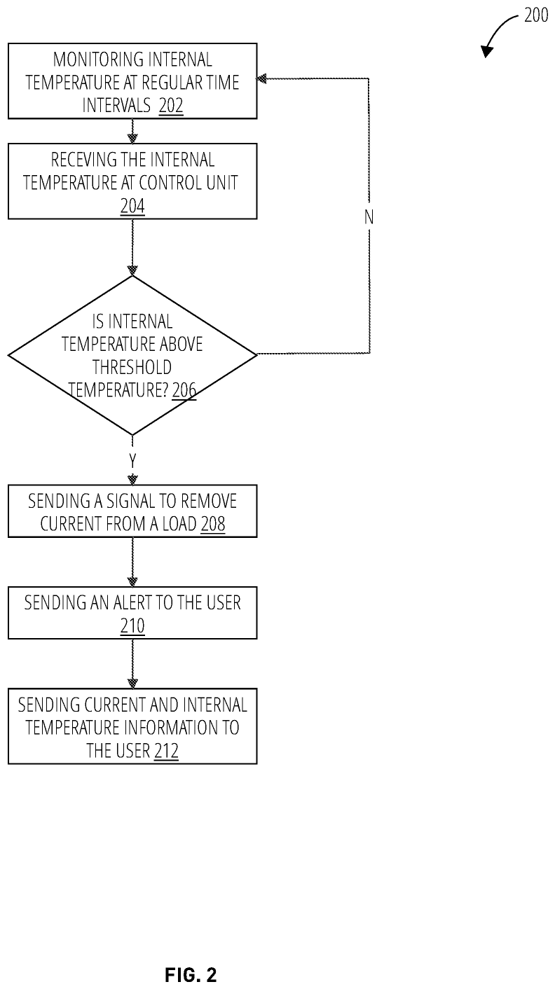

FIG. 2 shows a method 200 for protecting a smart electrical socket. The steps include monitoring the internal temperature at regular time interval (block 202), sending the internal temperature to the control unit (block 204), checking if the internal temperature is above the threshold temperature (decision block 206), when the internal temperature is above the threshold temperature then sending a deactivation signal to a relay to remove current from the a load (block 208), sending an alert to the user (block 210) and sending current and internal temperature to the user (block 212).

If the internal temperature is not above the threshold temperature, then the method returns to monitoring the internal temperature.

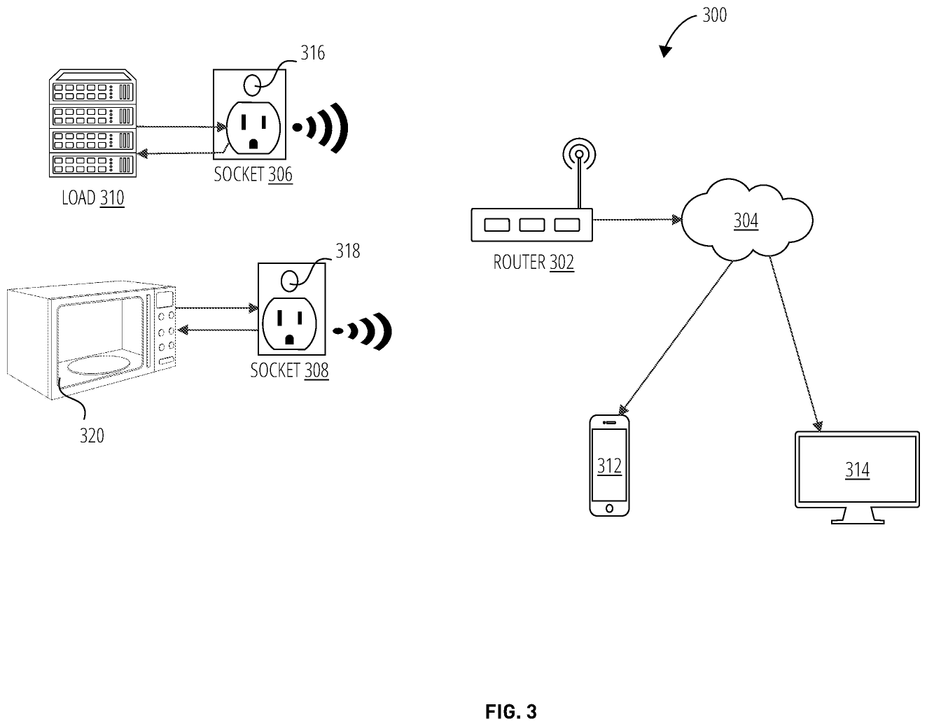

FIG. 3 shows a system 300 providing an overview of the implementation of the methods and systems of the disclosure connected to different types of loads, such as a server (load 310), microwave oven (load 320), etc.

In an example, socket 306 including LED 316 and socket 308 including LED 318 are smart electrical sockets with a thermal fuse breaker circuit. The LED 316 and LED 318 provide an indication of the output state.

The thermal fuse breaker circuit continuously monitors the internal temperature of the socket at certain intervals and removes the current from the load when the internal temperature is above the value of the threshold temperature. Thus, providing protection from a hazardous condition.

The smart electrical socket may also provide early detection of a problem by communicating via a wireless network that may include a router 302. For example, the smart electrical socket may be configured to operate on any of 16 ZigBee channels. The smart electrical socket may be programmed to send current and temperature information to a cloud network server 304 so that a user may access this information when desired. The user may choose to receive this information on a device such as a computer 314, a smart phone 312, via a webpage, SMS, email, an application, etc.

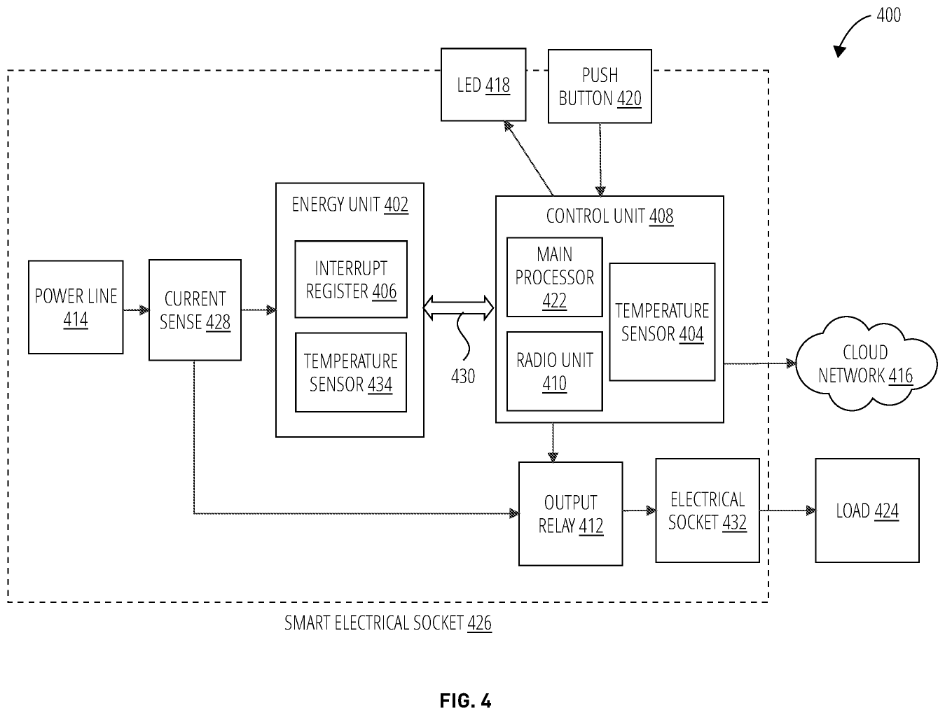

FIG. 4 shows a block diagram of an environment 400 that includes a load 424 connected to a smart electrical socket 426. The smart electrical socket 426 may include a power line 414, a current sense 428, an energy unit 402, a control unit 408, an LED 418, a push button 420 and an output relay 412. The energy unit 402 may include an interrupt register 406. The control unit 408 may include a main processor 422, a temperature sensor 404, and a radio unit 410.

The current sense 428 may be a resistor that draws a current when the load 424 is connected to the power line 414. When a load 424 is connected to the smart electrical socket 426, the control unit 408 monitors the internal temperature of the electrical socket 432 using the temperature sensor 404. The internal temperature is the temperature on the main processor 422, which is near the electrical socket 432. In an embodiment, the main processor 422 is coupled thermally via copper ground planes and close proximity to provide reliable thermal protection to the electrical socket 432. When the load 424 draws current, the temperature increases. During a failure condition, the internal temperature may increase excessively resulting in melting of solder or plastic, circuit boards etc. The internal temperature is measured at a regular interval of time using the interrupt register 406. The measured temperature is sent to the control unit 408 via Bus 430. For example, the communication between energy unit 402 and control unit 408 may be executed using an SPI bus. The control unit 408 includes a main processor 422 that executes logic to compare the internal temperature with a threshold temperature value. When the internal temperature is above or greater than the threshold temperature, the control unit 408 sends a deactivation signal to the output relay 412. The output relay 412 receives the deactivation signal and removes the power supply to the load 424.

In some configurations, the energy unit 402 may include a temperature sensor 434 that may be utilized in combination with the temperature sensor 404 of the control unit 408

An LED 418 indicates the output state of the smart electrical socket 426 and a push button 420 may be included to allow a toggle state input, which may be used to turn on the smart electrical socket 426 when it trips.

Further, the radio unit 410 may include a wireless controller to broadcast information to a user on a cloud network 416. This information may include the internal temperature, current, voltage. The user may use this information to diagnose the problems that cause socket failure, meltdowns or any other damages possible from a failed outlet electrical connection.

An estimate of AC contact temperature when thermometer is located remotely. The problem arises during reduction to practice when this invention is applied to pre-existing designs, whereby the temperature sensing element is not in an ideal location. The invention intends to account for thermal gradients and losses by measuring and correlating actual temperature rise to the estimated one.

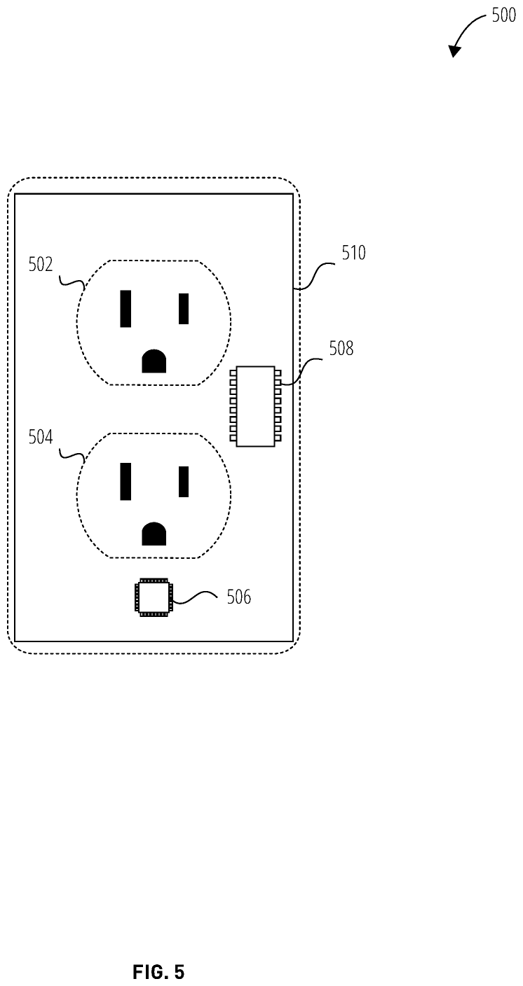

FIG. 5 displays an example of a dual smart electrical socket 500 showing the relative internal positioning of the contact 502, contact 504, microcontroller 506, and relay 508 of a PCB 510. The contact 502 and contact 504 are the female AC contacts for voltage that are the target of desired temperature sensing. In this configuration, microcontroller 506 may have the only available thermometer, which is built into the microcontroller chip. In this configuration, there would be considerable distance between the two points, with conductivity paths through PCBs, ground planes, traces, standoffs and screws. In other words, the thermal coupling is not tight. The chip may have cooling paths of its own, and may never reach as high of a temperature as the metal contacts are able achieve. In order to compensate for this, the temperature rise (above ambient) for the metal on contact 502 and contact 504 may serve the function of contact resistance where power dissipation is given by:

ΔT=k*P=k*I²

Thermal coupling coefficient k may be given in degrees C. per Watt.

By driving a large AC current through the contacts, the contact 502 and contact 504 may heat up. Comparing the actual metal temperature at a given current to the temperature rise on the microcontroller 506, the error may be calculated. For example, if at 15 amps the temperature rise of metal is 26° C., but the microcontroller 506 measures only 19° C., a determination may be made that the error due to coupling losses is 7° C. Using the above equation and this difference, the value for k is 7/152 or 0.03. From this calculation a first order correction may be implemented to estimate actual metal temperature based on the temperature of the microcontroller 506 using the following:

Tₘ=T_{c}+k*I²

where Tₘ=metal temperature and Tc=microcontroller temperature. Experimental measurement of k may be necessary. Once k is known however, implementation is straightforward, as long as the smart socket is able to measure current. Having a more accurate estimate of temperature leads to improved thermal shutdown, as relay 508 may break the circuit if temperatures get too high.

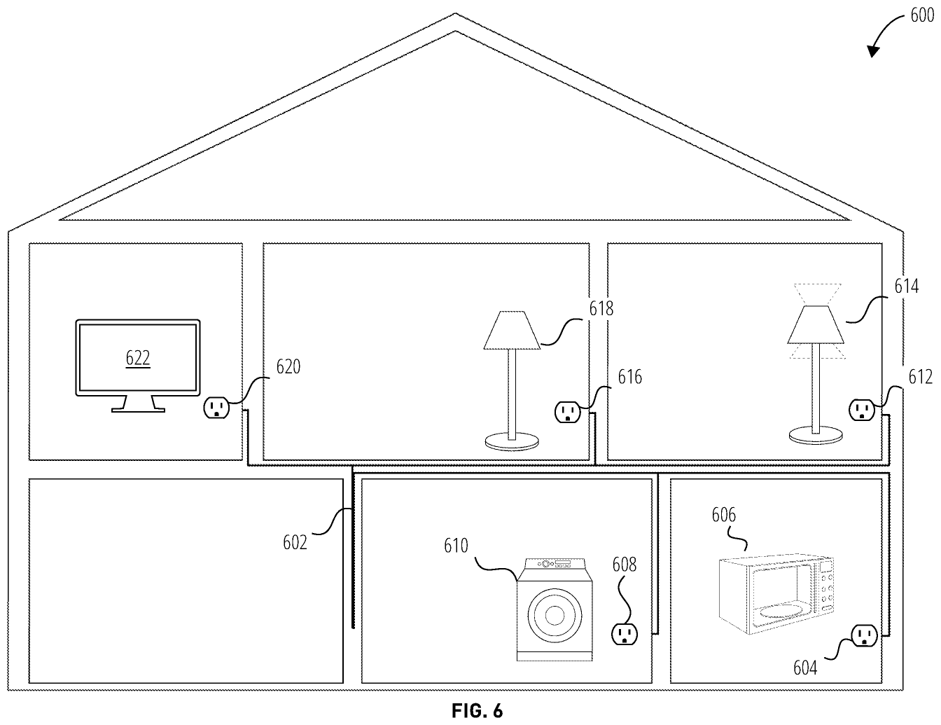

FIG. 6 illustrates a cross sectional view of an environment 600 comprising smart electrical socket 604, smart electrical socket 608, smart electrical socket 612, smart electrical socket 616, and smart electrical socket 620 distributed throughout the different floors of the building and in electrical communication with a power line 602. Each of the smart sockets is connected to an appliance in the environment 600. For instance, the smart electrical socket 604 is connected to microwave 606, the smart electrical socket 608 is connected to a washing machine 610, the smart electrical socket 612 is connected to a light 614 that is on, the smart electrical socket 616 is connected to a light 618, and the smart electrical socket 620 is connected to a monitor 622. During operation of the environment 600, each time a smart electrical socket turns off, whether it's from scheduling or from an overload shut down, the smart electrical socket measures the resistance of the power line 602. For example, if shut off occurs at the smart electrical socket 608 due to the load from the washing machine 610, the smart electrical socket 608 may measure the voltage change due to the drop in the current. This may be done by measuring a voltage drop associated with a large current as soon as it turns off, followed by the voltage going back up to line voltage. This may be calculated through an r=V/I calculation for calculating resistance. In an embodiment, this calculation may be incorporated into the operation of the smart electrical socket.

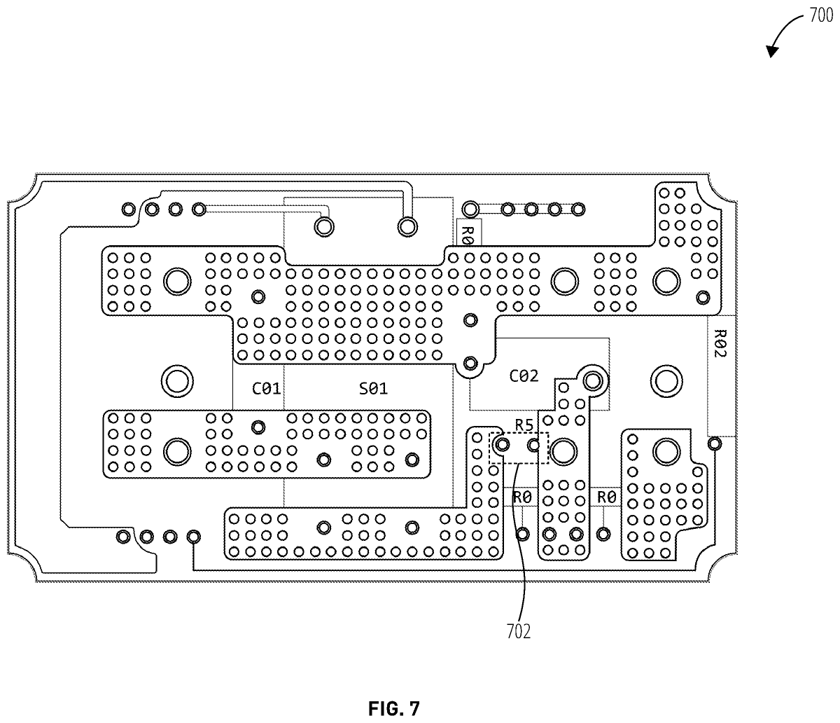

FIG. 7 illustrates a chip 700 utilized in the smart electrical socket. The chip 700 may include a separate thermistor 702 soldered in close proximity to LINE contacts, thus giving a faster responding thermal readings. The thermistor 702 may be part of a simple resistor divider that generates voltage proportional to temperature (over a reasonable range), which is then measured remotely by an analog-to-digital converter. In various configurations, the analog-to-digital processor may be on a separate board.

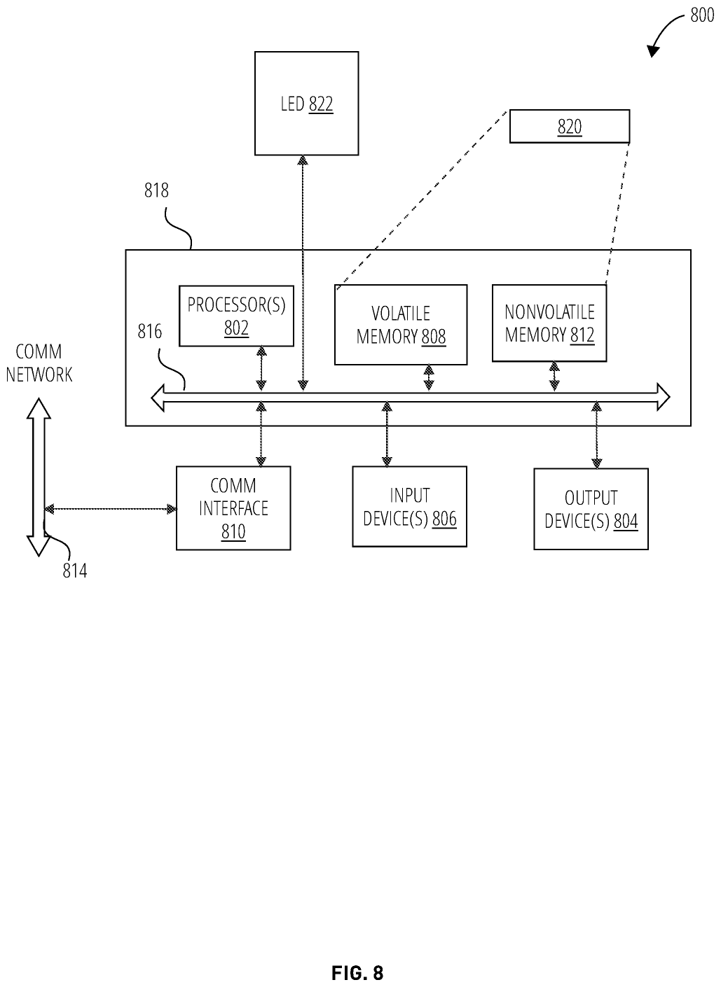

FIG. 8 is an example block diagram of a device 800 that may incorporate embodiments of the present invention. FIG. 8 is merely illustrative of a machine system to carry out aspects of the technical processes described herein and does not limit the scope of the claims. One of ordinary skill in the art would recognize other variations, modifications, and alternatives. In one embodiment, the device 800 typically includes an LED 822, a data processing system 818, a communication network interface 810, input device(s) 806, output device(s) 804, and the like.

As depicted in FIG. 8, the data processing system 818 may include one or more processor(s) 802 that communicate with a number of peripheral devices via a bus subsystem 816. These peripheral devices may include input device(s) 806, output device(s) 804, communication network interface 810, and a storage subsystem, such as a volatile memory 808 and a nonvolatile memory 812.

The volatile memory 808 and/or the nonvolatile memory 812 may store computer-executable instructions and thus forming logic 820 that when applied to and executed by the processor(s) 802 implement embodiments of the processes disclosed herein.

The input device(s) 806 include devices and mechanisms for inputting information to the data processing system 818. These may include a push button and the like. The input device(s) 806 typically allow a user to change the state of the device. For example, when the smart electrical socket trips, the user may turn it back on using the input device(s) 806. The input device(s) 806 may also include external sensors, such as temperature sensors.

The output device(s) 804 include devices and mechanisms for outputting information from the data processing system 818. These may include the output relay, infrared LEDs, electrical socket and so on as well understood in the art.

The communication network interface 810 provides an interface to communication networks (e.g., communication network 814) and devices external to the data processing system 818. The communication network interface 810 may serve as an interface for receiving data from and transmitting data to other systems. Embodiments of the communication network interface 810 may include an Ethernet interface, a modem (telephone, satellite, cable, ISDN), (asynchronous) digital subscriber line (DSL), FireWire, USB, a wireless communication interface such as Bluetooth or Wi-Fi, a near field communication wireless interface, a cellular interface, and the like.

The communication network interface 810 may be coupled to the communication network 814 via an antenna, a cable, or the like. In some embodiments, the communication network interface 810 may be physically integrated on a circuit board of the data processing system 818, or in some cases may be implemented in software or firmware, such as “soft modems”, or the like.

The device 800 may include logic that enables communications over a network using protocols such as HTTP, TCP/IP, RTP/RTSP, IPX, UDP and the like.

The volatile memory 808 and the nonvolatile memory 812 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 808 and the nonvolatile memory 812 may be configured to store the basic programming and data constructs that provide the functionality of the disclosed processes and other embodiments thereof that fall within the scope of the present invention.

Logic 820 that implements embodiments of the present invention may be stored in the volatile memory 808 and/or the nonvolatile memory 812. Said logic 820 may be read from the volatile memory 808 and/or nonvolatile memory 812 and executed by the processor(s) 802. The volatile memory 808 and the nonvolatile memory 812 may also provide a repository for storing data used by the logic 820.

The volatile memory 808 and the nonvolatile memory 812 may include a number of memories including a main random access memory (RAM) for storage of instructions and data during program execution and a read only memory (ROM) in which read-only non-transitory instructions are stored. The volatile memory 808 and the nonvolatile memory 812 may include a file storage subsystem providing persistent (non-volatile) storage for program and data files. The volatile memory 808 and the nonvolatile memory 812 may include removable storage systems, such as removable flash memory.

The bus subsystem 816 provides a mechanism for enabling the various components and subsystems of data processing system 818 communicate with each other as intended. Although the communication network interface 810 is depicted schematically as a single bus, some embodiments of the bus subsystem 816 may utilize multiple distinct busses.

It will be readily apparent to one of ordinary skill in the art that the device 800 may be a device such as a smart electrical socket. As commonly known in the art, the device 800 may be implemented as a collection of multiple networked computing devices. Further, the device 800 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

The methods and apparatuses in this disclosure are described in the preceding on the basis of several preferred embodiments. Different aspects of different variants are considered to be described in combination with each other such that all combinations that upon reading by a skilled person in the field on the basis of this document may be regarded as being read within the concept of the invention. The preferred embodiments do not limit the extent of protection of this document.

Having thus described embodiments of the present invention of the present application in detail and by reference to illustrative embodiments thereof, it will be apparent that modifications and variations are possible without departing from the scope of the present invention.

What is claimed is:

1. A method of protecting a smart electrical socket, the method comprising:
monitoring an internal temperature of the smart electrical socket connected to a load, wherein the smart electrical socket comprises:
an electrical socket;
an output relay, wherein the output relay is connected between a power line and the electrical socket and upon receipt of a deactivation signal removes an electrical connection between the power line and the electrical socket;
a timer comprising:
an interrupt status register, wherein the timer includes logic to provide an accurate interval timer for sending out report packets; and
a control unit comprising:
a processor; and
a temperature sensor;
wherein the processor includes logic to operate the temperature sensor to measure the temperature at time intervals sent by the interrupt status register, to determine if the internal temperature is above a threshold temperature, and to send the deactivation signal to the output relay to shut off the power line to the load;
comparing the internal temperature to the threshold temperature; and
sending the deactivation signal to the output relay if the internal temperature is above the threshold temperature.

2. The method of claim 1, wherein the timer further comprises an energy meter chip that provides information to the control unit, the information including at least one of a current, voltage, internal temperature and combinations thereof.

3. The method of claim 1 and claim 2, wherein the control unit further comprises a radio unit, the radio unit receiving information, and broadcasting to a user.

4. The method of claim 1, wherein the control unit sends an alert signal to indicate an output state of the smart electrical socket.

5. The method of claim 1, wherein the smart electrical socket comprises plastic, and the threshold temperature is higher than a normal operation temperature and less than a melting point of solder or the plastic.

6. A smart electrical socket comprising:
an electrical socket;
an output relay;
an energy unit;
a control unit;
a processor; and
a memory storing instructions that, when executed by the processor, configure the smart electrical socket to:
monitor an internal temperature of the smart electrical socket connected to a load,
wherein the output relay is connected between the electrical socket and a power line and upon receipt of a deactivation signal can remove an electrical connection between the power line and the electrical socket,
wherein the energy unit comprises a temperature sensor, and the energy unit includes logic to control the temperature sensor, and measures the internal temperature of the electrical socket at a regular time interval,
wherein the control unit comprises the processor, and the processor includes logic to determine if the internal temperature is above a threshold temperature and to send the deactivation signal to the output relay to shut off the power line to the load;
compare the internal temperature to the threshold temperature; and
send the deactivation signal to the output relay if the internal temperature is above the threshold temperature.

7. The smart electrical socket of claim 6, wherein the energy unit further comprises an energy meter chip that provides information to the control unit, the information including at least one of a current, voltage, internal temperature and combinations thereof.

8. The smart electrical socket of claim 6, wherein the control unit further comprises a radio unit, the radio unit configured to receive information, and broadcasting to a user.

9. The smart electrical socket of claim 6, wherein the control unit is configured to send an alert signal to indicate an output state of the smart electrical socket.

10. The smart electrical socket of claim 6, wherein the smart electrical socket comprises plastic, and the threshold temperature is higher than a normal operation temperature and less than a melting point of solder or the plastic.

11. The smart electrical socket of claim 6, the energy unit comprises an integrated temperature sensor.

12. A method of operating a system of smart electrical sockets, the method comprising:
positioning a smart electrical socket between a load and a power line, wherein the smart electrical socket comprises an electrical socket, an output relay, a timer, and a control unit;
monitoring an internal temperature of the smart electrical socket connected to the load through operation of the timer and the control unit, wherein the timer comprises an interrupt status register, and the control unit comprises a processor and a temperature sensor;
operating logic on the timer to:
provide an accurate interval timer for sending out report packets to the control unit;
operating logic on the processor to:
measure temperature at time intervals sent by the interrupt status register through the temperature sensor;
determine if the internal temperature is above a threshold temperature, at least one of a current, voltage, internal temperature; and
send a deactivation signal to the output relay if the internal temperature is above the threshold temperature to shut off the power line to the load;
removing an electrical connection between the power line and the electrical socket through operation of the output relay connected between the power line and the electrical socket in response to receipt of the deactivation signal; and
measuring voltage drop in the power line caused by the removal of the electrical connection to the load by the output relay to calculate power lines resistance.

13. The method of claim 12, wherein the power lines resistance is utilized in the calculation of the threshold temperature.

14. The method of claim 12, wherein the timer further comprises an energy meter chip that provides information to the control unit, the information including the at least one of a current, voltage, internal temperature and combinations thereof.

15. The method of claim 12, wherein the control unit further comprises a radio unit, the radio unit receiving information, and broadcasting to a user.

16. The method of claim 12, wherein the control unit sends an alert signal to indicate an output state of the smart electrical socket.

17. The method of claim 12, wherein the smart electrical socket comprises a plastic, and the threshold temperature is higher than a normal operation temperature and less than a melting point of solder or the plastic.
